(19) United States
(12) Patent Application Publication
(10) Pub. No.: US 2015/0118372 A1
(43) Pub. Date: Apr. 30, 2015

(54) PROCESS FOR TREATING COCOA CAKE

(71) Applicant: James F. Albus, Fleetwood, PA (US)

(72) Inventor: James F. Albus, Fleetwood, PA (US)

(21) Appl. No.: 14/064,870

(22) Filed: Oct. 28, 2013

(51) Int. Cl. A23G 1/00

(52) U.S. Cl. CPC A23G 1/0016
USPC 426/461

(57) ABSTRACT

Preground cocoa cake powder is mixed with pH neutral or alkalized water and continuously fed into a recirculating jet mill operated by superheated steam. In the mill, butterfat is separated while the cocoa cake is ground to a uniform fine particle size. Flash vaporization of the water mixed with the cake causes the particles to “explode,” improves separation of butterfat, and aids in the grinding action of the mill. Solid particles in the exit stream of the mill are recovered by cyclone separation, as a finely ground, defatted, cocoa product. Exhaust gases and butterfat exiting the cyclone separator system are fed into a desuperheater, where butterfat is recovered. The exhaust of the desuperheater is delivered to a bag collector for further separation and recovery. Other components that have a negative effect on the cocoa powder are neutralized and/or removed, providing an enhanced taste to the final product.

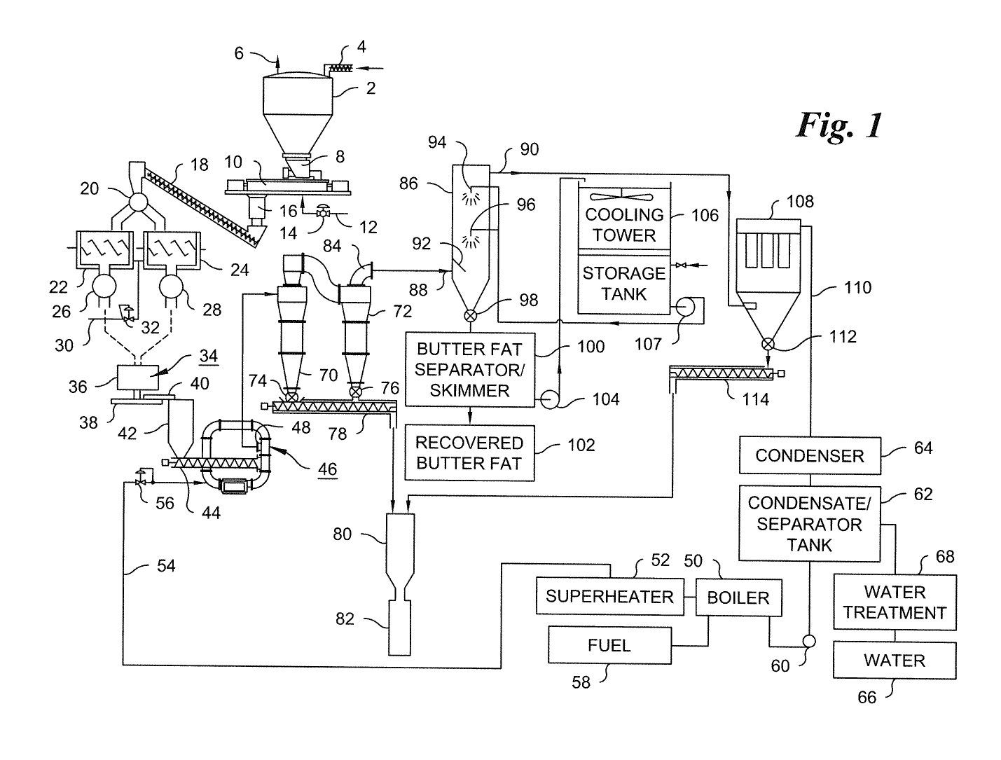

### FIELD OF THE INVENTION

This invention relates to the processing of cocoa, and particularly to an improved method and apparatus for treating cocoa cake, utilizing steam as a grinding medium in a recirculating jet mill.

### BACKGROUND OF THE INVENTION

A cocoa bean is generally ¾-1.0 inch in length, and consists of a thin outer shell, butterfat, and solids including the germ along with moisture. The moisture content is normally less than 7.0%. The major part of the cocoa bean is cocoa butter, typically about 55% on a dry weight basis. The initial processing steps conducted on the fermented cocoa bean consist of cleaning to remove foreign matter, roasting to develop flavor and reduce moisture, and winnowing, primarily to remove the cocoa shell. The cleaning, roasting and winnowing steps yield broken pieces of cocoa solids in varying sizes, referred to as “nibs.” A large nib fraction, composed of the largest, or premium, pieces, which contain up to about 55-56% butterfat, is used to produce top grade chocolate and cocoa powder.

The next fraction is the small nib fraction, which also contains significant quantities of cocoa butter, typically from 35 to 48%. The small nibs also contain a higher percentage of shell and germ. The small nib fraction can be processed further, and mixed with large nibs for making lower grades of chocolate or cocoa. As an alternative, the small nib fraction is frequently subjected to expeller pressing for extraction of cocoa butter.

A third fraction is nib dust, which is not suitable for cocoa powder manufacture, but which also contains significant quantities of cocoa butter, typically from 30 to 36, and is therefore useful for expeller pressing.

A fourth fraction consists primarily of shell dust and small shell particles. The shell dust and small shell particles also contain significant quantities of cocoa butter, and may therefore be subjected to expeller pressing for cocoa butter extraction. Typically, the shell dust and small shell fragments are mixed into blends with other winnowing products for expeller pressing.

A fifth fraction is the large shell fraction, which does not contain significant quantities of cocoa butter.

The small nib, nib dust and shell dust/small shell particles fractions, can all be subjected to expeller pressing for the extraction of cocoa butter. Expelling is carried out by an expeller press, which is typically a screw press which subjects the winnowing products to very high pressures, often as high as 30,000 psig, to force out cocoa butter. The expeller press operates by forcing material into a tapered tube by means of a rotating screw. Pressure on the material increases as it travels along the length of the tube, and liquid cocoa butter is forced out through slits in the tube. What is left after the cocoa butter is removed is known as “expeller cake”.

Expeller cake, especially if it results from expeller pressing of the small nib fraction or of a blend including a significant small nib component, is potentially usable in some cocoa powder applications. However, heretofore expeller cake has been extremely difficult to grind, and it has an inferior taste and color. For these reasons, expeller cake has not been considered useful for food products. Furthermore, it has not been considered for use in food products because of its fibrous character, and because it frequently contains unacceptably high quantities of insect fragments and rodent hairs, and has a very high count of bacteria such as salmonella.

Expeller cake of small nib type or of the nib dust type, or of the shell dust/small shell particle type typically contains significant quantities of cocoa butter, typically at ratios as high as 14%. Because expelling is a mechanical process, it cannot separate out all the available butterfat. Therefore, cocoa butter solids are sometimes extracted from expeller cake using solvents such as hexane or cryogenic liquid CO₂. However, there are governmental restrictions on the use of solvent-extracted cocoa butter for food purposes, at least in the United States.

This invention provides an efficient and effective process for utilizing expeller cake in the manufacture of a product marketable as a sterilized acceptable grade cocoa powder, or as a component thereof, by treating the expeller cake to reduce significantly, or even completely eliminate, fiber, insect fragments, rodent hair and bacteria, and thereby not only satisfy government standards but produce a value-added product.

The invention also provides an efficient and effective means for grinding expeller cake down to a very fine particle size so that it is usable in drinks, ice creams and other food products requiring finely ground cocoa powder having improved suspension qualities.

The invention also provides for the efficient and effective recovery of residual cocoa butter from various grades of expeller cake, normally in the range of 10.0-12.0%, without the need for solvent extraction.

The invention also provides an efficient process for producing a defatted cocoa powder, having a low butterfat content, e.g., less than about 1.0, useful in low-calorie food applications.

### SUMMARY OF THE INVENTION

In accordance with the invention, processing of cocoa powder or cocoa cake takes place on a continuous basis, with several operations carried out simultaneously. The process uses superheated steam (SHS) at pressures ranging from 3 to 200 psig and temperatures ranging from 250° F. and 600° F., depending upon the starting raw feed and desired end product.

In accordance with the invention, raw expeller cake is first mechanically preground, for example, to approximately 80 mesh, and water is blended with the cake, preferably both prior to and following pregrinding. The water can also be treated with an alkali to produce both an alkalized powder and butterfat. The blend of water and cocoa cake is introduced continuously into a recirculating jet mill, into which superheated steam is also continuously introduced. The jet mill can be a loop type jet mill such as the jet mill described in U.S. Pat. No. 7,832,664, granted Nov. 16, 2010. Further grinding of the preground raw cocoa cake takes place within the jet mill, with the steam acting both as a grinding medium and as an oxidation-preventing atmosphere. The water blended with the coarsely ground cocoa cake before it is introduced into the recirculating jet mill is flashed to steam by the heat of the superheated steam within the mill and simultaneously causes the cake particles to explode and sterilizes them, producing a very finely ground product. The application of heat to the resulting cocoa product by the superheated steam also separates the butterfat, which is carried off with the exiting steam.

Centrifugal separation of particles takes place within the recirculating jet mill. That is, fine particles are continuously drawn off from the mill, while coarse particles are recirculated within the mill for further grinding and butterfat separation. The exiting stream, containing steam, butterfat and fine solid particles, is delivered from the mill to a separator unit, which can consist of one or more cyclone separators. In the separator unit, most of the sterilized, insect free, value added, solid matter is settled out for recovery as usable cocoa powder. The steam, butterfat, and remaining solids are first passed through a spray condenser, which causes liquid butterfat particles in the nanometer to micron size range to drop out into a separator and post recovery unit. Any remaining gases, butterfat and solids are then passed through a bag collector for separation of remaining solid particulate matter. The bag collector is followed by condensers for further liquid cocoa butterfat recovery.

### BRIEF DESCRIPTION OF THE DRAWING

The single FIGURE is a schematic diagram of an apparatus for carrying out the treatment process of the invention.

### DETAILED DESCRIPTION

Cocoa cake is fed into a raw feed bin 2 by a loading device such as screw conveyor 4. The bin has a cover exhaust outlet 6 at the top, and a variable speed feeder screw assembly 8, or a similar metering device, at the bottom. The feeder screw assembly 8 delivers the expeller cake from the bin, to a mixer 10. An example of a suitable mixer is a Young twin-shaft paddle mixer, available from Young Industries, Inc. of Muncy, Pa. The twin-shaft paddle mixer has a double U-shaped trough with twin agitators. These agitators rotate toward each other, simultaneously blending material and moving it along the mixer.

Water from a water line 12 is delivered through a valve 14 to the mixer. Typically, the amount of water added ranges from about 10% to about 25% of the weight of material fed through the mixer. The valve and the mixer speed are adjusted accordingly. Alkalis such as potassium, sodium or ammonium carbonate, potassium, sodium or ammonium hydroxide, potassium, sodium or ammonium bicarbonate, or mixtures of any of the foregoing, may be included in the water added at this point to improve color and flavor. Alkalization begins to take place in mixer 10.

A mechanical pulverizing mill 16 receives material from the outlet of the mixer 10. Various types of pulverizing mills can be used. A particularly suitable mill is the Szego Mill, described in U.S. Pat. No. 4,063,687, issued Dec. 20, 1977. The Szego mill is a comminution device in which a crushing mass having an outer surface with a helical configuration is mounted on a rotary support which rolls the crushing mass around the interior surface of a cylindrical crushing chamber. The rotary support is a flexible wire rope which permits limited radial movement of the crushing mass, allowing inertial and gyroscopic forces to aid in grinding. The pregrinding of the cocoa cake which takes place in pulverizing mill 16 contributes to energy efficiency in the overall grinding operation in two ways. First, it reduces the expeller cake particles to an optimum size for more efficient processing in the jet mill. Second, it exposes more surface area of the expeller cake to the water introduced into the mixer through water line 12. Thorough mixing of water with the expeller cake contributes to the efficient operation of the jet mill.

The product of the pulverizing mill is fed by a conveyor 18, preferably a screw conveyor, to a valve 20, which delivers the pulverized product to a pair of jacketed ribbon blenders 22 and 24 in an alternating sequence.

Valves 26 and 28, at the outlets of blenders 22 and 24 respectively, open in alternation, valve 26 being open while valve 20 is delivering expeller cake to blender 24, and valve 28 being open while valve 20 is delivering expeller cake to blender 22. Thus, by alternating operation of the valves, the twin mixers can deliver uniformly mixed expeller cake continuously.

Further mixing takes place in the blenders through contact between the water from line 12 and the surfaces of the cocoa cake particles newly exposed by the action of the pulverizing mill 16. Thus, initial blending of water with the cocoa cake takes place within the paddle mixer, and further blending takes place in blenders 22 and 24.

The blender jackets are supplied with hot condensate from another part of the system through a line 30 and a flow-limiting valve 32.

Heated, cocoa cake powder is delivered from the ribbon blenders to a table feeder 34, which comprises a bin 36 and a table 38. The bin and table rotate together while a stationary plow 40 extends into an adjustable gap between the bin and the table. The plow delivers material smoothly and continuously as the bin and table rotate. Material is then delivered through a hopper 42 to a screw feeder 44, which feeds material into a jet mill 46.

Jet mill 46 can be a recirculating jet mill of the type described in U.S. Pat. No. 7,832,664, granted Nov. 16, 2010. The jet mill comprises a continuous, loop-shaped, toroidal conduit in which solid particles are circulated along with a gas. Laterally opposed gas jets in the lower part of the toroidal conduit cause the circulating solid particles to collide with one another, thereby effecting a grinding action on the particles. The laterally opposed relationship of the gas jets aids grinding while reducing wear of the jet mill.

In the jet mill, as particles are reduced in size, they are classified according to size within the mill. Larger particles congregate towards the outside of the toroid, while smaller particles congregate toward the inside. The smaller particles and exit from the toroid along with gases and butterfat through an outlet 48 in the inside wall of the toroid.

The jet mill is operated by superheated steam generated by a boiler 50 and superheater 52. Superheated steam is delivered through line 54 and through flow limiting valve 56 to the jet nozzles within the lower part of the jet mill. The steam supply apparatus includes fuel tank 58 for operation of the boiler and superheater, a pump 60, which delivers water to the boiler from condensate/separator tank 62, a condenser 64 which receives steam from other parts of the system, to condense water and separate out any residual liquid butterfat, and a water make-up supply 66, a water treatment system 68.

As mentioned previously initial blending of water with the cocoa cake takes place within the paddle mixer, and further blending takes place in blenders 21 and 22. Still further blending of water with the cocoa cake takes place in the jet mill.

The jacketed blenders transfer heat to the pulverized expeller cake for control of swelling and control of the temperature of the product, and assist in preventing condensation from taking place in the jet mill.

A mixture of steam and fine particles of processed powder cake is delivered from the exit opening 48 of jet mill 46 to the inlet of a separator system composed of two consecutive cyclone separators 70 and 72. Gases, which include butterfat, exit from the primary collector unit of the first separator 70 and enter the feed inlet of the second separator 72. Product settling out in the cyclone separators is delivered through rotary air locks 74 and 76 to a jacketed heat exchanger/conveyor 78, from which the finished product is delivered to a hopper 80, and from the hopper to a bagger 82. The bagger can be a pneumatic bagger, preferably one with an automatic weighing scale.

The gas outlet 84 of cyclone separator 72 is connected to a desuperheater spray condenser 86, which comprises a vertically elongated cylindrical tank having an inlet opening 88 near its lower end and having an outlet opening 90 near its upper end. An inclined baffle 92, on the inside wall of the cylindrical tank a short distance above inlet opening 88, is provided in order to divert steam and any entrained microscopic liquid butterfat particles entering the tank downwardly, and to disperse the steam and butterfat particles so that they do not avoid the spray from water nozzles 94 and 96. The spray from the water nozzles in the spray condenser 86 initiates a drop in temperature, and can also cause condensation of water and removal of any steam-entrained butterfat particles within the tank. The temperature at the exit of the desuperheater spray condenser 86 is preferably between 250° and 300° F., but can be less if desired. The liquid condensate and any residual butterfat are delivered through a valve 98 at the bottom of the desuperheater spray condenser to a separator/skimmer 100 and from the separator/skimmer to a collection tank 102 for delivery to butterfat recovery units (not shown). Additional baffles may be provided within the desuperheater spray condenser to provide additional surface area for condensation. Condensate is pumped by a pump 104 to a cooling tower 106 for recirculation through a pump 107 to the spray nozzles within the desuperheater/condenser.

Any remaining uncondensed steam and residual butterfat are delivered from the desuperheater/condenser through outlet opening 90 to a bag collector 108. Steam and any butterfat passing through the bag collector are delivered through line 110 to condenser 64. Any solid materials delivered through rotary valve 112 are delivered to the finished product hopper 80 via a heat exchanger/conveyor 114. Although provisions may be made in the condensate/separator tank 64 for skimming any residual butterfat which passes through the bag collector, ordinarily most of the butterfat separated within the jet mill will have been collected in the desuperheater and delivered along with condensate from the bottom of the desuperheater.

In the operation of the apparatus described above, the water added to the cocoa cake in the paddle mixer 10 is carried with the cake into the steam-operated jet mill 46, and causes rapid explosion and breakdown of the cocoa cake particles within the jet mill by its rapid vaporization upon contact with superheated steam. The rapid explosion and breakdown which takes place by reason of the presence of water in the cocoa cake, along with the high velocity grinding action of the jet mill, produce an extremely finely ground product with good color and taste, suitable for use as cocoa powder in drinks, ice cream and similar food products. The pretreatment of the expeller cake by mixing it with water in mixer 10 is beneficial not only because it contributes to the effectiveness of grinding in the jet mill, but also because it aids in reducing the temperature of the steam at the outlet of the jet mill, and allows for more efficient cooling of the cocoa powder after it exits the rotary valves of the cyclone separators.

Insect fragments, rodent hair and other undesired particles are completely disintegrated and destroyed within the steam-operated jet mill, and are either undetectable or reduced to satisfactory levels in the finished product. Any microscopic fragments that remain are sterilized by the heat of the superheated steam so that there is nothing objectionable in the final product.

Compared with present mechanical milling of cocoa cake, the apparatus and process of this invention produce a finer and more uniform product unaffected by ambient conditions, and produce a product with less powdered fiber. The amount of powdered fiber present in the product can be determined by comparing the amount of material capable of passing through a screen when treated with water, with the amount of material capable of passing through the same screen when treated with petroleum ether. In one test made using the process of the invention, and comparing it with milling of expeller cake using a Raymond roller mill, it was found that 2.0% of the product of the roller mill failed to pass through a 200 mesh screen when treated with petroleum ether, whereas 2.8% failed to pass through the screen when treated with water. In the case of expeller cake treated in accordance with the invention, 1.2% of ether-tested product failed to pass through the 200 mesh screen, and 1.2% of water-tested expeller cake failed to pass through the screen. These results indicate that there was very little water-absorbing cocoa fiber in the product of the invention, whereas higher quantities were present in the product of the roller mill.

Similar tests using a 325 mesh screen showed a small difference between ether-tested product and water-tested product both with the invention and with the roller mill. With the roller mill, 7.3% of ether-treated product remained, whereas 10% of the water-treated remained. With the invention, 2.0% of the ether-treated product remained, and 3.0% of the water-treated product remained. These results indicate that the product milled in accordance with the invention is finer and more uniform than the product of a convention roller mill.

The invention makes it possible to produce a valuable cocoa product from cocoa powder, especially from poorer grades of cocoa powder, and at the same time to extract significant quantities of residual cocoa butter from the cake without the need for solvents. The invention is far superior to other known methods for grinding lower quality cake in terms of the ability to produce high quality products with improved color, taste and sterilization, and in terms of grinding efficiency, production rate and energy efficiency.

1. A process for treating cocoa cake comprising the steps of:
pregrinding pressed or expelled cocoa cake using mechanical pregrinding means, thereby producing a preground raw cocoa cake;
blending water with the preground raw cocoa cake;
introducing the preground raw cocoa cake and water blend into a recirculating jet mill
introducing superheated steam into the recirculating jet mill, grinding the preground raw cocoa cake in the mill using steam as the grinding medium, and drawing off fine ground particles of cocoa powder along with steam from the jet mill while recirculating coarse particles;
separating a major part of said fine ground particles from steam exiting from the mill for use as cocoa power; and
passing the steam remaining after the separation step through a desuperheater and thence to means for separation of remaining particulate matter from the steam.

2. The process according to claim 1, including the step of drawing off butterfat collected in the desuperheater.

3. The process according to claim 1, including the step of drawing off butterfat collected in the desuperheater and in said means for separation of the remaining particulate matter from the steam.

4. The process according to claim 1, in which said water blended with the preground cocoa cake includes an alkali, and including the step drawing off alkalized butterfat collected in the desuperheater.

5. The process according to claim 1, in which said water blended with the preground cocoa cake includes an alkali, and including the step drawing off alkalized butterfat collected in the desuperheater and in said means for separation of the remaining particulate matter from the steam.

5. The process according to claim 1, in which water is added to the cocoa cake prior to the mechanical pregrinding step and in which the blending step is carried out at least in part in the mechanical pregrinding means.

6. The process according to claim 1, in which water is added to the cocoa cake prior to the mechanical grinding step, and in which the blending step is carried out at least in part downstream of the mechanical grinding means.

7. The process according to claim 1, in which the blending of water with cocoa cake takes place at least in part in blending means downstream of the pregrinding means, and in which heat is added to the material in said blending means.

8. The process according to claim 1, in which an alkali is added to the cocoa cake in sufficient quantity to effect a color change therein.

9. The process according to claim 1, in which the temperature in said jet mill is maintained at a level sufficiently high that sterilization of said preground raw cocoa cake is carried out during the grinding thereof in said jet mill.

10. The process according to claim 1, in which insect fragments are disintegrated and sterilized using superheated high velocity steam.
